(19) United States
(12) Patent Application Publication
(10) Pub. No.: US 2005/0044253 A1
(43) Pub. Date: Feb. 24, 2005

(54) Modem for xDSL system having EOC command filtering function and method of processing EOC command in the modem

(75) Inventor: Chang-hoon Oh, Seongnam-si (KR)

Correspondence Address: Steven M. Mills;MILLS & ONELLO LLP, Suite 605, Eleven Beacon Street, Boston, MA, 02108, US

(73) Assignee: Samsung Electronics Co., Ltd.

(21) Appl. No.: 10/832,944

(22) Filed: Apr. 27, 2004

(30) Foreign Application Priority Data
Jul. 25, 2003 (KR) 03-51633

(51) Int. Cl. G06F 15/16

(52) U.S. Cl. 709/230

(57) ABSTRACT

A modem for an x digital subscriber line (xDSL) communication system having an embedded operational channel (EOC) command filtering function and a method of processing the EOC command in the modem are provided. In the modem for an xDSL system having the EOC command filtering function, the is connected to a first host that is one of a subscriber terminal and a central office server. The modem is connected to a counterpart modem connected to a second host that is the other of the subscriber terminal and the central office server via a telephone line. Data communication is provided between the first host and the second host. The modem for an xDSL system includes a host data processing unit and a physical medium dependent unit. When receiving a predetermined interrupt signal, the host data processing unit receives and processes an EOC command output from the physical medium dependent unit, and then outputs EOC information as a result. When it is decided that the EOC command is a meaningful EOC command, the physical medium dependent unit outputs an interrupt signal and the EOC command, receives the EOC information, and converts the EOC information together with modulated first data into a first data stream. In the. modem for an xDSL system having an EOC command filtering function and in the method of processing EOC commands in the modem, there is an advantage that the manufacturing cost as well as the number of interrupts in processing the EOC commands can be reduced, because only meaningful EOC commands are processed.

### BACKGROUND OF THE INVENTION

This application claims the priority of Korean Patent Application No. 2003-51633, filed on Jul. 25, 2003, in the Korean Intellectual Property Office, the disclosure of which is incorporated herein in its entirety by reference.

1. Field of the Invention

The present invention relates to a modem for an x digital subscriber line (hereinafter, referred to as “xDSL”) system and a method of processing an embedded operational channel (hereinafter, referred to as “EOC”) command, and more particularly, to a modem for an xDSL communication system having an EOC command filtering function and a method of processing the EOC command.

2. Description of the Related Art

In general, an xDSL system is a communication technology in which data can be transmitted fast in a full-duplex manner without additional lines by using twisted-pair lines. An example of a general xDSL system is shown in FIG. 1. Referring to FIG. 1, a subscriber 10 and a central office 30 are connected to each other through a telephone line 20, and the subscriber 10 and the central office 30 perform data communications with each other through the telephone line 20. The subscriber 10 includes a subscriber modem 11 and a subscriber terminal 12, and the central office 30 includes a central office modem 31 and a communication server 32. The communication server 32 provides a network 40. Here, the subscriber terminal 12 may be implemented by a personal computer (PC), etc. Another example of such an xDSL system is disclosed in U.S. Pat. No. 6,163,599.

Generally, besides a channel for data transmission, a virtual channel for transmitting status information and performance monitoring parameter of a modem, is additionally provided in the xDSL system. Such a channel is called as an EOC.

In the xDSL system, a central office modem transmits a specific EOC command to a subscriber modem through the EOC so as to request status information of the subscriber modem or control a specific operation of the subscriber modem. The subscriber modem transmits relevant information in response to the EOC command received from the central office modem through the EOC. Such a method of sending and receiving the EOC commands is defined as an EOC protocol. The EOC protocol used in the xDSL system is defined in an xDSL standard for compatibility between products manufactured by different makers.

The modem used in the xDSL system includes a physical medium dependent unit (hereinafter, referred to as “PMD”) and a host module. The PMD performs a physical signal exchange with a counterpart modem. The host module processes the received data into data practically usable in a host.

The modem for an XDSL system will be described in detail with reference to FIGS. 2A and 2B. FIGS. 2A and 2B are diagrams illustrating a conventional modem for an XDSL system in detail. FIG. 2A shows a modem for an xDSL system in which means for processing an EOC command is implemented in the PMD, and FIG. 2B shows a modem for an XDSL system in which means for processing an EOC command is implemented in the host module. Examples of subscriber modems are described with reference to FIGS. 2A and 2B.

First, referring to FIG. 2A, a modem 50 includes a host data processing unit 51 and a PMD 52. The host data processing unit 51 reconstructs data DATAI received from the PMD 52 as data DATAIT usable in a host, that is, in a PC 70, by using an upper layer protocol. In addition, the host data processing unit 51 converts data DATAOT received from the PC 70 into data DATAO for transmission, and then transmits the data to the PMD 52. The PMD 52 includes an interface unit 53, an EOC processing unit 54, and a physical layer data processing unit 55. The interface unit 53 receives a data stream from a central office 60 via a telephone line 61, divides the data stream into an EOC command EOC_CMD and data DATAI, and outputs them. The EOC processing unit 54 receives and processes the EOC command EOC_CMD, and then transmits the processing result, that is, EOC information EOC_IF, to the central office 60 via the interface unit 53. Furthermore, the physical layer data processing unit 55 transmits the data DATAIT to the host data processing unit 51, and transmits the data DATAO to the central office 60 via the interface unit 53.

However, like the conventional modem 50 for an xDSL system, it may be a waste of hardware that the EOC processing unit 54 is implemented in the PMD 52 as hardware. This is because the EOC protocol processing operation by the EOC processing unit 54 is necessary only for practical data communication, but is not necessary for initialization of the modem for communication. In addition, even if the EOC processing unit 54 is designed as software, in a case where the EOC processing unit 54 has limited memory space, it may be difficult to implement the EOC protocol.

Next, referring to FIG. 2B, a modem 80 includes a host data processing unit 81 and a PMD 82. The host data processing unit 81 reconstructs data DATAI received from the PMD 82 into data DATAIT usable in a host, that is, in a PC 70 by using the upper layer protocol. The host data processing unit 81 converts data DATAOT received from the PC 70 into data DATAO for transmission, and then transmits the data to the PMD 82. The host data processing unit 81 includes an EOC processing module 91 which is implemented with software. The EOC processing module 91 processes EOC command EOC_CMD received from the PMD 82. The host data processing unit 81 transmits the process result of the EOC processing module 91, i.e., EOC information EOC_IF, to the PMD 82.

The PMD 82 includes an interface unit 83 and a physical layer data processing unit 84. The interface unit 83 receives data stream from the central office 60 via the telephone line, and divides the data stream into the EOC command EOC_CMD and the data DATAI to output them. The interface unit 83 transmits the EOC command EOC_CMD to the EOC processing module 91. At that time, the interface unit 83 outputs an interrupt signal INT to the host data processing unit 81. When receiving the interrupt signal INT, the host data processing unit 81 recognizes that the interface unit 83 receives an EOC command, and receives the EOC command EOC_CMD from the interface unit 83.

The physical layer data processing unit 84 transmits the data DATAI to the host data processing unit 81, and transmits the data DATAO to the central office 60 via the interface unit 83.

Here, in the xDSL system such as ISDN (Integrated Services Digital Network), ADSL (Asymmetric Digital Subscriber Line), and SHDSL (Symmetric High-bit-rate Digital Subscriber Loop), it is prescribed as an EOC protocol standard that only EOC commands which are received successively three times are processed, and EOC commands which are received successively only once or twice are not processed.

But, like the conventional modem 80 for an xDSL system, in a case that an EOC processing module is implemented in a host data processing unit, performance of the host data processing unit will be negatively affected. This is because an interrupt signal is output to the host data processing unit whenever the PMD receives an EOC command EOC_CMD. Moreover, in the same manner of ISDN, ADSL, and SHDSL described above, the number of times the interrupt signal is generated will be increased in the xDSL system which transmits each EOC command by three times.

Furthermore, in a case that the number of interrupt signals INT which the host data processing unit can receive is defined, since the host data processing unit cannot receive an additional interrupt signal, there is a problem that the EOC commands can not be processed properly. In addition, since the host data processing unit handles the EOC information used in the PMD, there are difficulties that the PMD has to transmit the EOC command to the host data processing unit whenever the EOC command is received, and receives the processing result from the host data processing unit again.

### SUMMARY OF THE INVENTION

The present invention provides a modem for an xDSL system capable of processing only meaningful EOC commands by filtering EOC commands, and a method of processing the EOC commands in the modem.

According to an aspect of the present invention, there is provided a modem for an x digital subscriber line (xDSL) system having an embedded operational channel (EOC) command filtering function, the modem being connected to a first host that is one of a subscriber terminal and a central office server, being connected to a counterpart modem connected to a second host that is the other of the subscriber terminal and the central office server via a telephone line, and providing data communication between the first host and the second host, the modem comprising a host data processing unit and a physical medium dependent unit. The host data processing unit modulates first data received from the first host, outputs the modulated first data, demodulates a predetermined modulated second data, and outputs the demodulated second data to the first host. The host data processing unit, when receiving a predetermined interrupt signal, receives and processes the EOC command output from the physical medium dependent unit, and then outputs EOC information. The physical medium dependent unit converts the modulated first data into a first data stream, transmits the first data stream To the counterpart modem via the telephone line, divides a second data stream received from the counterpart modem into the modulated second data and an EOC command, and outputs them. The physical medium dependent unit, when it is decided that the EOC command is a meaningful EOC command, outputs the interrupt signal and the EOC command, receives the EOC information, and converts the EOC information together with the modulated first data into the first data stream.

In one embodiment, the host data processing unit comprises an EOC state handler which executes a predetermined state machine program to process the EOC command and output the EOC information. The physical medium dependent unit can include an interface unit which converts the modulated first data and the EOC information into the first data stream and divides the second data stream into the modulated second data and the EOC command; a physical layer data processing unit which receives the modulated first data from the first host to output it to the interface unit, and receives the modulated second data to output it to the first host, and an EOC filter which decides whether the EOC command is a meaningful EOC command or not, and outputs the EOC command together with the interrupt signal when the EOC command is the meaningful EOC command. The EOC filter can have an EOC command filtering function that the EOC command is decided to be a meaningful EOC command when the EOC command has a correct EOC command format. The EOC filter can have an EOC command filtering function that the EOC command is decided to be a meaningful EOC command when the same EOC command is received by the set number of times. The EOC filter can include a memory which stores the meaningful EOC command temporarily.According to another aspect of the present invention, there is provided a method of processing embedded operational channel (EOC) commands in a modem for an x digital subscriber line (xDSL) system having an EOC command filtering function, the modem comprising a host data processing unit which receives and processes an EOC command when receiving a predetermined interrupt signal and outputs EOC information, and a physical medium dependent unit which outputs the interrupt signal and the EOC command when the EOC command received via a telephone line is decided to be a meaningful EOC command, the method comprising steps of:

(a) receiving the EOC command;

(b) acquiring a meaningful EOC command by filtering the received EOC command;

(c) processing the acquired meaningful EOC command using an EOC state machine program, and outputting EOC information; and

(d) returning to step (b) when an additional EOC command is received.

In one embodiment, step (b) comprises steps of: (b1) deciding that the EOC command is a meaningful EOC command when the received EOC command has a correct EOC command format, and (b2) outputting the interrupt signal and the EOC command which is decided to be the meaningful EOC command to the host data processing unit. In one embodiment, the method further includes: (b3) storing the EOC command in a predetermined memory provided in the physical medium dependent after step (b1), when it is decided that the EOC command is a meaningful EOC command; and (b4) erasing the EOC command stored in the memory, after step (b2).

In one embodiment, step (b) comprises steps of: (b1) deciding whether the received EOC command is equal to an EOC command received previously, when the received EOC command has a correct EOC command format; (b2) storing the received EOC command in a first set address of a predetermined memory provided in the physical medium dependent, when the received EOC command is equal to the previously received EOC command; (b3) storing the received EOC command in a second set address of the memory when the received EOC command is not equal to the previously received EOC command, and then returning to step (b1); (b4) counting the number of receiving EOC commands equal to the EOC command and accumulate the count value, after step (b2); (b5) deciding that the EOC command is a meaningful EOC command when the accumulated count value reaches a set value; (b6) outputting the interrupt signal and the EOC command which is decided to be a meaningful EOC command to the host data processing unit; and (b7) erasing the EOC command stored in the memory.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a conceptual view showing a general xDSL system.

FIGS. 2A and 2B are diagrams showing a conventional modem for an xDSL system in detail.

FIG. 3 is a diagram showing a modem for an xDSL system capable of filtering an EOC command according to one embodiment of the present invention.

FIG. 4 is a flowchart showing a flow of processing an EOC command in a modem for an xDSL system capable of filtering an EOC command according to an embodiment of the present invention.

FIG. 5A is a flowchart showing an example of the flow for filtering the EOC command shown in FIG. 4.

FIG. 5B is a flow chart showing another example of the flow for filtering the EOC command shown in FIG. 4.

FIG. 6 is a diagram showing an EOC state machine as an example of program used in the flow of processing an EOC command shown in FIG. 4.

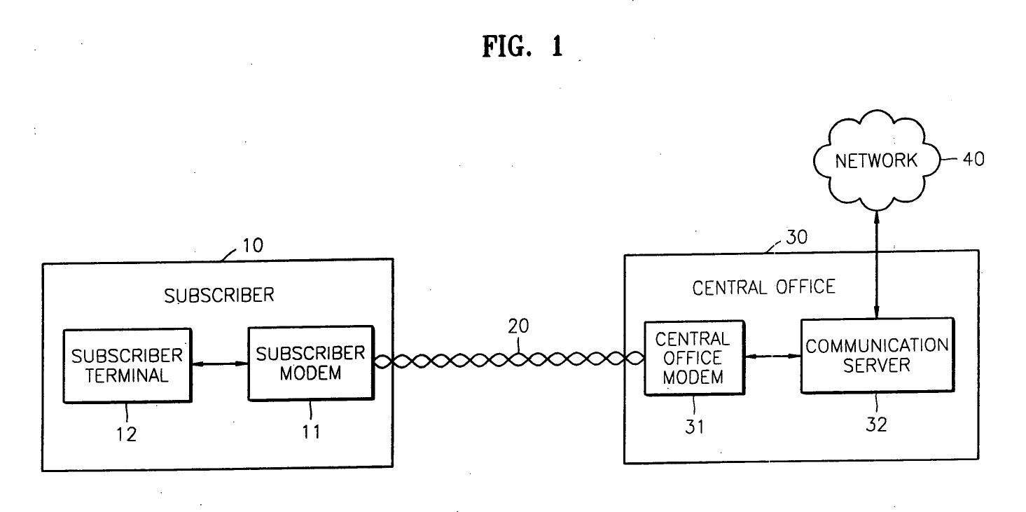

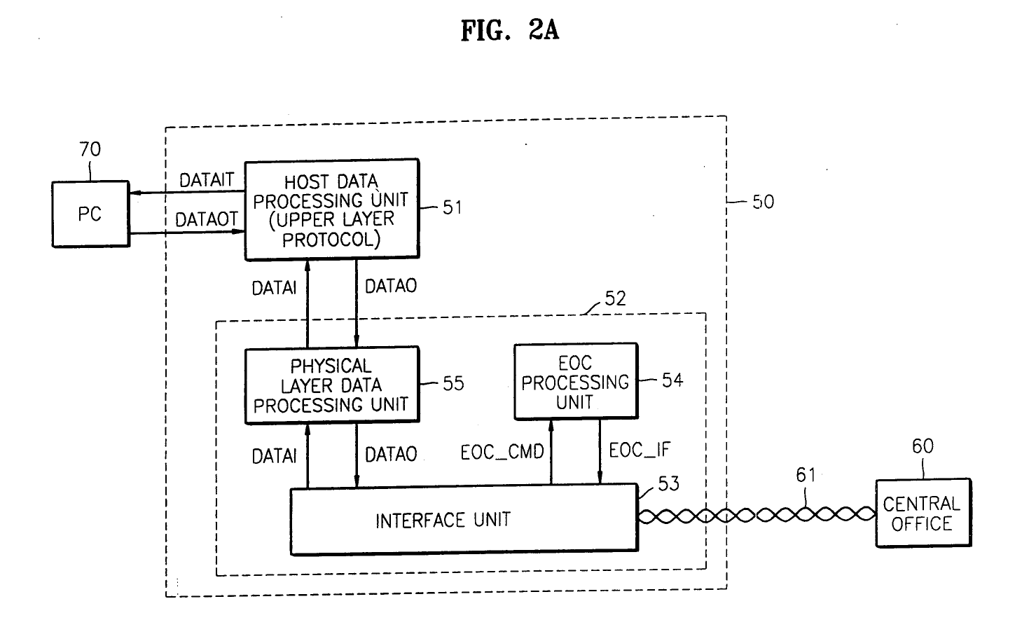

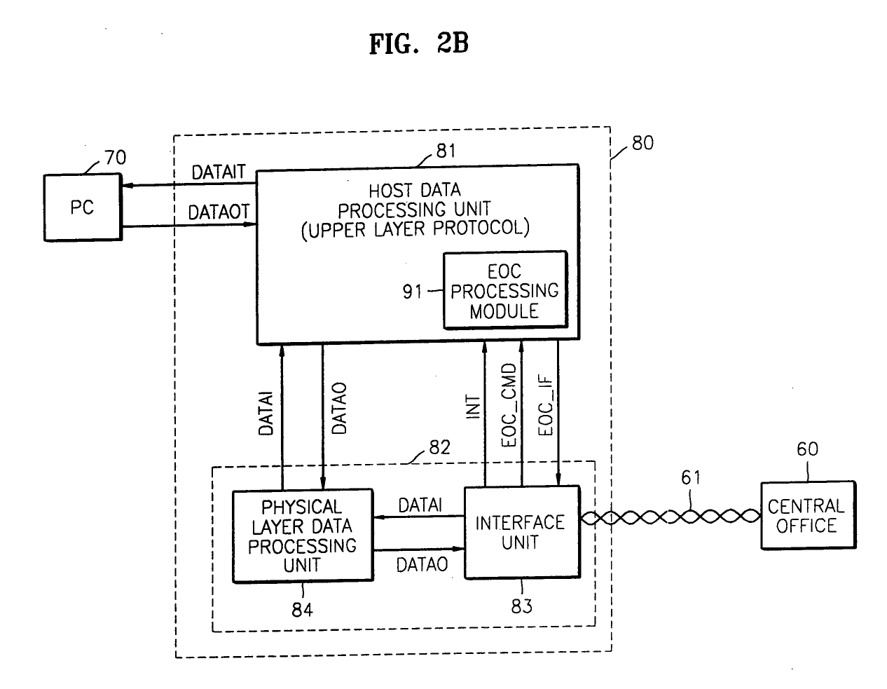

### DETAILED DESCRIPTION OF THE INVENTION

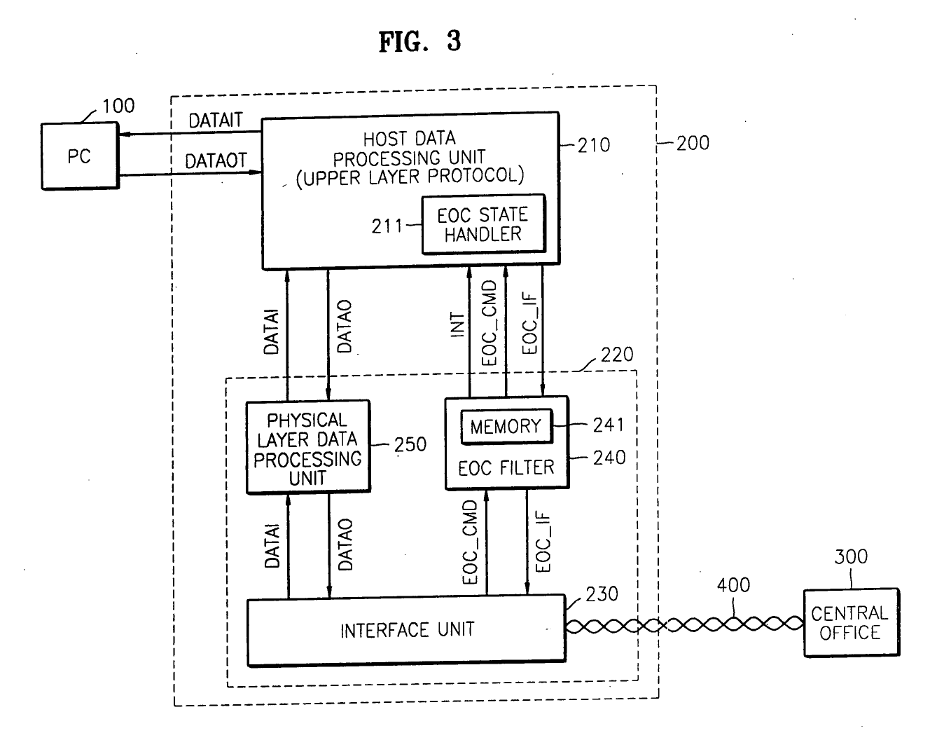

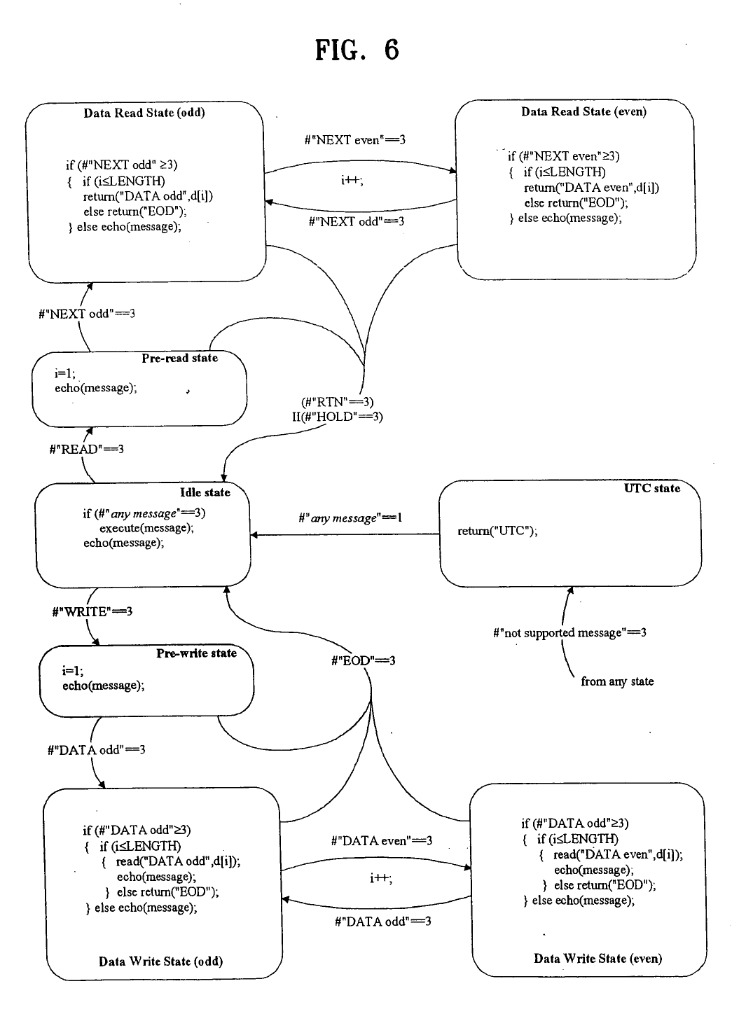

FIG. 3 is a diagram showing a modem for an xDSL system capable of filtering an EOC command according to an example of the present invention. Referring to FIG. 3, a modem 200 includes a host data processing unit 210 and a PMD 220. The host data processing unit 210 restructures data DATAI received from the PMD 220 as data DATAIT usable in a host, i.e., a PC 100 using the upper layer protocol. Further, the host data processing unit 210 converts data DATAOT received from the PC 100 into data DATAO for transmission, and then transmits it to the PMD 220. The host data processing unit 210 also includes an EOC state handler 211 which is implemented with software. The EOC state handler 211 processes an EOC command EOC_CMD received from the MD 220. The EO state handler 211 processes the EOC command EOC_CMD using the state machine shown in FIG. 6. Herein, the state machine shown in FIG. 6 is a general program for processing EOC commands. Accordingly, detailed description thereof will be omitted. The host data processing unit 210 transmits the process result of the EOC state handler 211, i.e., EOC information EOC_IF to the PMD 220.

In FIG. 3, although the case where the host data processing unit 210 includes the EOC state handler 211 is described as an exemplary embodiment, the EOC state handler 211 may be designed in various ways provided that it is designed separately from the PMD 220. Thus, it is not necessary to include the. EOC state handler 211 in the host data processing unit 210.

The PMD 220 includes an interface unit 230, an EOC filter 240, and a physical layer data processing unit 250. The interface unit 230 receives data stream from a central office 300 via a telephone line 400, divides the data stream into the EOC command EOC_CMD and the data DATAI, and then outputs them.

The EOC filter 240 receives the EOC command EOC_CMD, and then decides whether it is a meaningful EOC command or not. Further, the EOC filter 240 stores the meaningful EOC command EOC_CMD temporarily in a memory 241 provided therein.

At that time, the EOC filter 240 decides that the EOC command EOC_CMD is a meaningful EOC command when having a correct EOC command format. Furthermore, in case of an xDSL system transmitting one EOC command several times, such as an ISDN, an ADSL, a SHDSL, etc., the EOC filter 240 decides that the EOC command EOC_CMD is a meaningful EOC command when the EOC command EOC_CMD has the correct EOC command format and is received for a set number of times.

The EOC filter 240, in the case in which the received EOC command EOC_CMD is a meaningful command, outputs an interrupt signal INT to the host data processing unit 210, and then outputs the EOC command EOC_CMD stored in the memory 241. Then, the EOC filter 240 erases the EOC command EOC_CMD stored in the memory 241, and waits for reception of a next EOC command EOC_CMD.

When receiving the interrupt signal INT, the host data processing unit 210 recognizes that the EOC filter 240 received an EOC command, and receives the EOC command EOC_CMD from the EOC filter 240.

The physical layer data processing unit 250 transmits the data DATAI to the host data processing unit 210, and transmits the data DATAO to the central office 300 via the interface unit 230.

Next, an operation flow of the modem for the xDSL system, as described above, according to the present invention will be described with reference to FIGS. 3 to 5B.

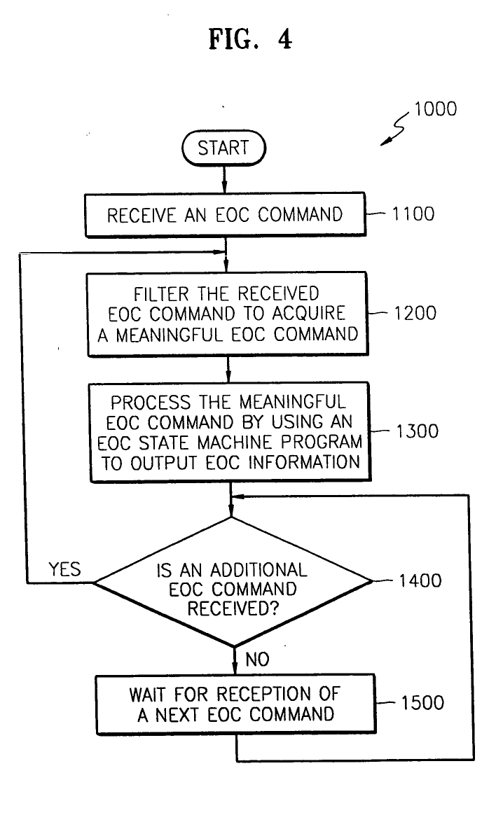

FIG. 4 is a flow chart showing a flow of processing an EOC command in a modem for an xDSL system capable of filtering an EOC command according to an embodiment of the present invention.

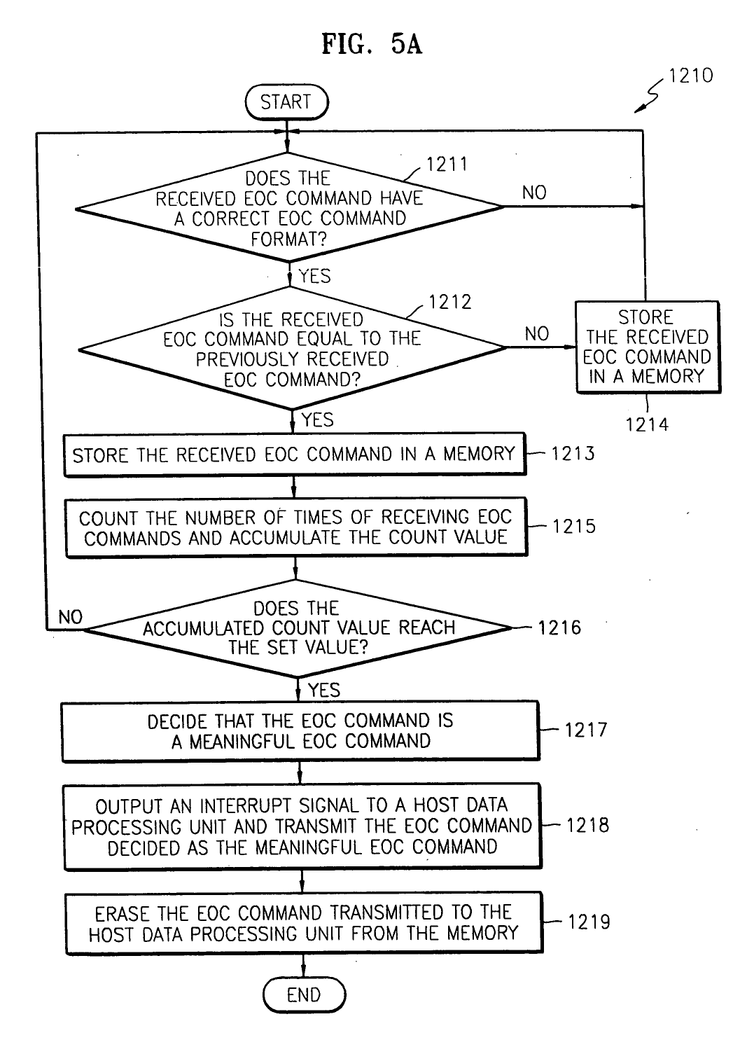

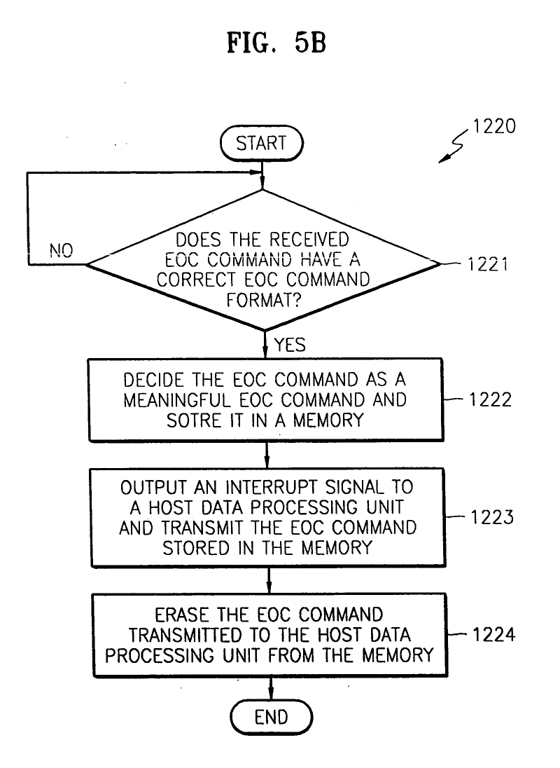

In FIG. 4, the interface unit 230 of the PMD 220 separates an EOC command EOC_CMD from data stream received from the central office 300 via the telephone line 400, and outputs it to the EOC filter 240 (1100). The EOC filter 240 receives the EOC command EOC_CMD from the interface unit 230, and filters the EOC command EOC_CMD, and thus acquires a meaningful EOC command EOC_CMD (1200). Step 1200 will be described below in detail with reference to FIGS. 5A and 5B.

The EOC filter 240 transmits the meaningful EOC command EOC_CMD to the host data processing unit 210. The host data processing unit 210 receives the meaningful EOC command EOC_CMD from the EOC filter 240. The EOC state handler 211 of the host data processing unit 210 processes the meaningful EOC command EOC_CMD using an EOC state machine program, and outputs an EOC information EOC_IF to the EOC filter 240 as a process result (1300). In addition, the EOC filter 240 receives the EOC information EOC_IF and outputs it to the interface unit 230, and the interface unit 230 transmits the EOC information EOC_IF to the central office 300 via the telephone line 400.

Then, the EOC filter 240 determines whether an additional EOC command EOC_CMD is received or not (1400). When an additional EOC command EOC_CMD is received in step 1400, flow returns to step 1200. Furthermore, when an additional EOC command EOC_CMD is not received in step 1400, the EOC filter 240 waits for reception of a next EOC command EOC_CMD (1500).

FIG. 5A, as a flow chart showing an embodiment of the flow for filtering the EOC command shown in FIG. 4, shows an EOC command filtering flow of the modem for the xDSL system transmitting one EOC command several times, such as the ISDN, the ADSL, the SHDSL, etc. In the flow chart of FIG. 5A, a flow where, when an EOC command EOC_CMD is received continuously, the EOC command EOC_CMD is filtered is described as an exemplary embodiment.

Referring to FIG. 5A, first, the EOC filter 240 determines whether the received EOC command EOC_CMD is a correct EOC command (1211). When the EOC command EOC_CMD received in the step 1211 is the correct EOC command, the EOC filter 240 determines whether the EOC command EOC_CMD is equal to the EOC command which was received previously and stored in the memory 241 (1212).

In step 1212, when the EOC command EOC_CMD is equal to the EOC command which was received previously, the EOC filter 240 stores the EOC command EOC_CMD in a first set address of the memory 241 (1213). Furthermore, in step 1212, when the EOC command EOC_CMD is not equal to the EOC command which was received previously, the EOC filter 240 recognizes that a new EOC command is received, and stores the EOC command EOC_CMD in a second set address of the memory 241, and then returns to step 1211 (1214).

Then, the EOC filter 240 counts the number of times when the same commands are received, and accumulates the count value (1215). When the accumulated count value reaches a set value, the EOC filter 240 determines whether the EOC command is a meaningful EOC command (1216, 1217). The EOC filter 240 outputs an interrupt signal INT to the host data processing unit 210, and transmits the EOC command EOC_CMD, which is determined to be the meaningful EOC command, to the host data processing unit 210 (1218). The EOC filter 240 erases the EOC command EOC_CMD, which is transmitted to the host data processing unit 210, in the memory 241 (1219).

FIG. 5B, which is a flow chart showing another embodiment of the flow for filtering the EOC command shown in FIG. 4, shows an EOC command filtering flow of the modem for the xDSL system transmitting one EOC command once, such as the VDSL. In the flow chart of FIG. 5B, a flow where, when an EOC command EOC_CMD is received continuously, the EOC command EOC_CMD is filtered is described as an exemplary embodiment.

Referring to FIG. 5B, first, the EOC filter 240 determines whether the received EOC command EOC_CMD has a correct EOC command format (1221). When it is determined in step 1221 that the received EOC command EOC_CMD has the correct EOC command format, the EOC filter 240 decides that the EOC command EOC_CMD is a meaningful EOC command, and stores it in the memory 241 (1222)

Then, the EOC filter 240 outputs an interrupt signal INT to the host data processing unit 210, and transmits the EOC command EOC_CMD, which is stored in the memory 241 EOC command, to the host data processing unit 210 (1223). The EOC filter 240 erases the EOC command EOC_CMD, which is transmitted to the host data processing unit 210, from the memory 241 (1224).

As described above, since the modem for an xDSL system according to the present invention comprises an EOC filter, only the meaningful EOC command filtered by the EOC filter is processed. Furthermore, since an interrupt signal is generated only when the EOC filter receives the meaningful EOC command, the number of interrupts which the host data processing unit should execute can be reduced.

Moreover, in the modem for an xDSL system according to the present invention, the EOC state handler which processes EOC commands is implemented with software in a host data processing unit, so that manufacture cost can also reduced, compared with the case where it is implemented with hardware in a PMD.

Although the present invention has been particularly shown and described with reference to exemplary embodiments thereof, it will be understood by those of ordinary skill in the art that various changes in form and details may be made therein without departing from the spirit and scope of the present invention as defined by the following claims.

As described above, according to the modem for an xDSL system and the method of processing EOC command in the modem, there is an advantage that only meaningful EOC commands filtered by the EOC filter are processed.

In addition, according to the modem for an xDSL system and the method of processing EOC command in the modem of the present invention, there is another advantage that the number of interrupts for processing the EOC command and the manufacture cost can be reduced.

1. A modem for an xDSL system having an embedded operational channel (EOC) command filtering function, the modem being connected to a first host that is one of a subscriber terminal and a central office server, being connected to a counterpart modem connected to a second host that is the other of the subscriber terminal and the central office server via a telephone line, and providing a data communication between the first host and the second host, the modem comprising:
a host data processing unit which modulates first data received from the first host, outputs the modulated first data, demodulates a predetermined modulated second data, and outputs the demodulated second data to the first host; and
a physical medium dependent unit which converts the modulated first data into a first data stream, transmits the first data stream to the counterpart modem via the telephone line, divides a second data stream received from the counterpart modem into the modulated second data and an EOC command, and outputs them,
wherein, when receiving a predetermined interrupt signal, the host data processing unit receives and processes the EOC command output from the physical medium dependent unit, and then outputs EOC information, and
wherein, when it is decided that the EOC command is a meaningful EOC command, the physical medium dependent unit outputs the interrupt signal and the EOC command, receives the EOC information, and converts the EOC information together with the modulated first data into the first data stream.

2. The modem for an xDSL system according to claim 1, wherein the host data processing unit comprises an EOC state handler which executes a predetermined state machine program to process the EOC command and output the EOC information.

3. The modem for an xDSL system according to claim 2, wherein the physical medium dependent unit comprises an interface unit which converts the modulated first data and the EOC information into the first data stream and divides the second data stream into the modulated second data and the EOC command;
a physical layer data processing unit which receives the modulated first data from the first host to output it to the interface unit, and receives the modulated second data to output it to the first host, and
an EOC filter which decides whether the EOC command is a meaningful EOC command, and outputs the EOC command together with the interrupt signal when the EOC command is the meaningful EOC command.

4. The modem for an xDSL system according to claim 3, wherein the EOC filter has an EOC command filtering function that the EOC command is decided to be a meaningful EOC command when the EOC command has a correct EOC command format.

5. The modem for an xDSL system according to claim 4, wherein the EOC filter has an EOC command filtering function that the EOC command is decided to be a meaningful EOC command when the same EOC command is received by the set number of times.

6. The modem for an xDSL system according to claim 5, wherein the EOC filter comprises a memory which stores the meaningful EOC command temporarily.

7. A method of processing embedded operational channel (EOC) commands in a modem for an xDSL system having an EOC command filtering function, the modem em comprising a host data processing unit which receives and processes an EOC command to output EOC information resultantly when receiving a predetermined interrupt signal, and a physical medium dependent unit which outputs the interrupt signal and the EOC command when the EOC command received via a telephone line is decided to be a meaningful EOC command, the method comprising steps of:
(a) receiving the EOC command;
(b) acquiring a meaningful EOC command by filtering the received EOC command;
(c) processing the acquired meaningful EOC command by using an EOC state machine program, and outputting EOC information; and
(d) returning to step (b) when an additional EOC command is received.

8. The method of processing EOC commands according to claim 7, wherein step (b) comprises:
(b1) deciding that the EOC command is a meaningful EOC command when the received EOC command has a correct EOC command format, and (b2) outputting the interrupt signal and the EOC command which is decided to be the meaningful EOC command to the host data processing unit.

9. The method of processing EOC commands according to claim 8, further comprising steps of:
(b3) storing the EOC command in a predetermined memory provided in the physical medium dependent after step (b1), when it is decided that the EOC command is a meaningful EOC command; and
(b4) erasing the EOC command stored in the memory, after the step b2.

10. The method of processing EOC commands according to claim 7, wherein step (b) comprises:
(b1) deciding whether the received EOC command is equal to an EOC command received previously, when the received EOC command has a correct EOC command format;
(b2) storing the received EOC command in a first set address of a predetermined memory provided in the physical medium dependent, when the received EOC command is equal to the previously received EOC command;
(b3) storing the received EOC command in a second set address of the memory when the received EOC command is not equal to the previously received EOC command, and then returning to step (b1);
(b4) counting the number of receiving EOC commands equal to the EOC command and accumulate the count value, after step (b2);
(b5) deciding that the EOC command is a meaningful EOC command when the accumulated count value reaches a set value;
(b6) outputting the interrupt signal and the EOC command which is decided to be a meaningful EOC command to the host data processing unit; and
(b7) erasing the EOC command stored in the memory.
